(19) United States
(12) Patent Application Publication
(10) Pub. No.: US 2003/0187727 A1
(43) Pub. Date: Oct. 2, 2003

(54) Sector-based animation system

(76) Inventors: Georges De Sousa-Calico Philippe, Grand Quevilly (FR); Dominique Tertrais Pierre-Francois, Notre Dame De Bondeville (FR)

Correspondence Address: Drinker Biddle & Reath LLP, One Logan Square, 18th and Cherry Streets, Philadelphia, PA, 19103-6996, US

(21) Appl. No.: 10/086,663

(22) Filed: Feb. 28, 2002

(51) Int. Cl. G06F 17/60

(52) U.S. Cl. 705/14

(57) ABSTRACT

System comprising a centre (C) linked to local stations connected to an audio system. The centre (C) has a microcomputer (Pi) managing a music bank, files for sample programmes, animation messages and a planner. Input means enable musical data to be entered and direct access means enable direct intervention on a local station. The musical data is sent to each local station, which transmits it to the audio system on the basis of the programme. The system enables the organisation personalised and sector-based animation for music programmes, messages, smells, digital images and lighting.

The invention relates to an adaptable, personalised, sector-based animation system for transmitting a music programme, messages, smells, digital images and lights based on pre-established but adaptable programmes.

Sound animation can be an important feature in boosting trade, particularly at sales locations such as hypermarkets, retail centres or shopping malls. Retail premises are not making efficient use of the potential inherent in such sound animation because the solutions which currently exist do not offer the qualities, features and options that are needed.

Apart from the known systems which involve running a pre-recorded loop, there are more advanced systems but these are still not very satisfactory.

A first of the existing solutions for producing audio animation involves replacing magnetic tape with an engraved CD, which is periodically renewed, for example every month. This solution is inflexible because it does not allow changes to be made during the time between changing the CD. In addition, although some direct intervention is possible, it requires the attendance of personnel at the sales premises, which is not always easy or practical if the staff are not sufficiently prepared for such procedures.

Finally, this rigid system does not allow short-term modifications to be made, for a period of one day or a few hours.

Another computerised system exists which is able to broadcast announcements via satellite but transmits to only one zone on a same site.

Finally, animation companies exist which send an events organiser and an engineer out to the site where an event is to take place.

This solution is only practical on an exceptional rather than a systematic basis, due to the high costs involved.

Apart from the rigidity of the known systems and their high cost if they are to be used with any degree of flexibility, one of their main disadvantages is the fact that they can lead to boredom because the same messages or pieces of music are systematically played in a loop with very little variation, causing staff who have to listen to this sound to become bored.

Even shoppers may be affected because the sound broadcast is often random and noisy with perceptible and even abrupt differences between different pieces of music or sudden interruptions by an announcer relaying a sales promotion message.

Sound animation could in fact be a considerable asset in boosting sales, especially at retail premises.

The objective of the present invention is to develop an adaptable, sensory, animation system which is sector-based and customised for sales premises, whether they be retail centres, hypermarkets or in town centres.

To this end, the invention relates to a system of the type defined above, characterised in that a management and control centre is linked to at least one local station connected to an audio system for supplying audio signals and a digital video projection system for supplying video signals to be transmitted

A) the centre comprising

a micro-computer managing

a music bank containing available music samples to compile music programmes for broadcasting,

a file of sample programmes,

a file of audio and video animation messages,

a planner file containing the broadcasting grids (broadcasting time of the sample programmes and messages) based on days and times of the day,

a file of clients and local stations linked to the centre,

input means for

musical data to set up, add to and renew the music bank by adding or deleting samples,

data relating to the clients,

information for updating client data,

direct access means for accessing a local station, the priority being its programmed operation,

an audio and video data compression means,

a PSTN modem or high-speed Internet link outputting from the centre in order to communicate with the local stations,

B) at least one local station comprising

a central unit and at least one hard disk receiving

the compressed samples, the compressed messages and compressed video and the video and samples programmes associated with the local station,

a decompression means at the station output,

a PSTN modem or high-speed Internet link at the input of the local station to communicate with the centre,

it being possible for each local station to connect to one or more communication systems via a local area network using the TCP/IP communication protocol. The network uses the services of a hub or general switch which can be connected to several other hubs (concentrator or multi-switch) or a switch depending on the size of the system.

C) the centre compiling, for each local station or group of local stations,

a programme of samples and animation messages containing the sample and message references,

a planner for the samples and messages (broadcasting dates),

the programme of samples being set up on the basis of information describing the site at which the audio system is located,

the centre transmitting to each local station

the compressed samples and messages, the non-compressed messages, the programmes of samples and messages and the planner for recording them in the local station,

the transmission of signals to the animation system being managed locally by the central unit of the local station on the basis of the programme of samples and messages and the planner, the audio and video signals being decompressed at the station output before being applied to the animation system.

Due to the flexibility of its deployment, an animation system of this type not only enables animated events to be organised in shopping galleries, town centres, department stores, hypermarkets or large shops, it can also be used in other premises visited by the public such as administrations and public services such as hospitals, railway stations, car parks, airports, conference or event venues.

This system allows the broadcast information (music samples, and animated video and audio messages, smells) to be transformed, adapted and changed almost instantaneously without the need to attend the site of the local station.

This process is capable of managing direct visual, audio and sensory marketing which is conducive to setting a backdrop and staging an event at the targeted environment by creating a themed atmosphere built around a specific scenario.

The music programmes are compiled on the basis of data relating to the site where they will be broadcast, taking account of the sector of the public at whom the audio, sensory and video messages are aimed depending on the time of day and the type of retail outlet. The messages may relate to the public but also to the on-site staff. Broadcasts may be programmed to start prior to opening to the public and may continue after closure to broadcast messages to staff who are preparing the site or tidying up at the end of the day.

Direct access can also be made available in response, to unforeseen events.

The system is particularly practical for the user, i.e. the site at which the local station is installed, given that no action is necessary and the management side is handled from the centre, which remotely controls the unit equipping the local station, either via the programme and planner or by direct access.

The only intervention handled locally is that required for maintenance, not managing the operations. This local intervention includes servicing systems other than that actually generating the sound, such as replacing consumables and in particular liquids dispensed by atomisers or diffusers, refilling products placed in sample dispensers and other systems of this type, which can be prompted by appropriate messages or signals.

The present invention will be described in more detail below with reference to an embodiment schematically illustrated in the appended drawings, in which:

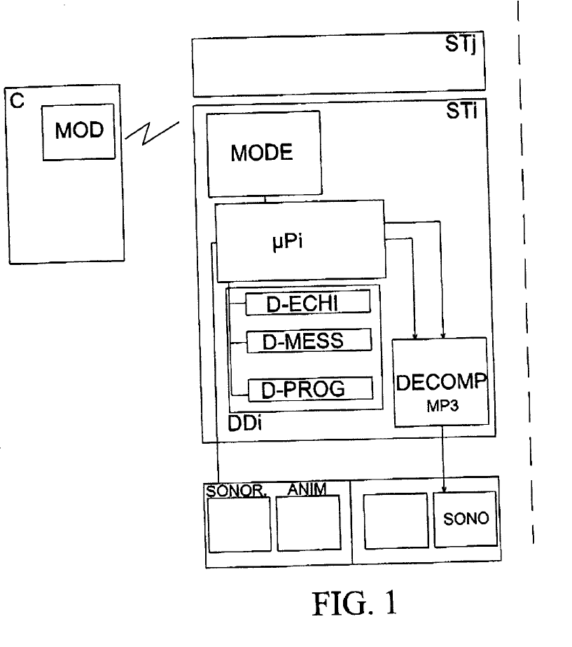

FIG. 1 shows an overall view of the system,

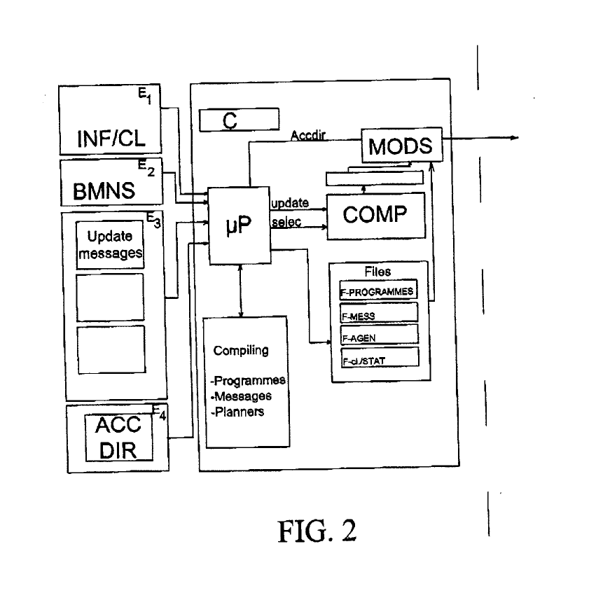

FIG. 2 is a block diagram illustrating the centre of the system.

As illustrated in the drawings, the invention relates to a personalised animation system, in particular a personalised audio animation system. This system can be adapted to broadcast a series of music samples and messages in accordance with pre-established but adaptable programmes, i.e. not fixed and which can be amended almost instantaneously.

The animation system is designed to perform global animation, including music, the creation of atmosphere in the surrounding area by lighting, smells and audio-visual animation through image projection, the broadcasting of illuminated, audio and sensory messages processed by local stations controlled by signals sent from the centre.

The voice and video messages may be publicity, commercial or promotional announcements or alternatively information of a general nature. The audio messages are primarily sound effects intended to create ambience, advantageously combined with illuminated, audio-visual and visual messages, which could also be judiciously combined with sensory messages by emitting perfume or smells from diffusers or atomisers on a command basis.

The system is made up of a centre C and local stations STi linked to the centre.

The centre C compresses the audio information and digital video data. The local station STi records this audio and digital video data and broadcasts it in accordance with a defined programme specific to the local station STi but put together by the centre in accordance with defined criteria depending on the local station and the requirements which the messages broadcast by the local station are intended to meet.

After compression, the different audio and digital video data is stored in the local station STi so that it can be broadcast directly, after decompression, via the combined audio SONO and video projection VIDEO system at the local station STi.

Throughout the description, the pieces of music to be broadcast will be referred to as music samples or simply samples. They represent samples or full musical works and messages as a whole.

The messages are sent by the microprocessor μPi either to an audio system SONOR which is separate from the system SON broadcasting the music samples or to the latter after decompression if necessary. The audio animation messages are also sent to this audio system or to specific systems such as sound effects systems. The video messages are sent to audio-visual video projection systems, the light messages are sent to light animation systems and the sensory messages are sent to the perfume or smell diffusers or atomisers.

As illustrated in FIG. 2, the centre C managing the system consists of a microcomputer μP. This microcomputer controls a music bank BMUS containing all the music samples ECHi available in the system. The microcomputer μP also manages a file of sample programmes F-PRECH associated with each client or local station STi, a file of messages to be broadcast F-MESS, also customised for each local station STi or group of local stations, and finally a planner file F-AG containing the broadcasting grids. These are periods at which the sample programmes and messages will be broadcast. This file is set up on the basis of days and times of the day, i.e. mainly depending on the type of public frequenting the site at the different times of the day or on different days of the week.

Finally, the centre has a file image necessary for managing the local stations F-CL/-STi linked to the centre C.

The centre C has input means E1, E2, E3, E4 for receiving the various items of information needed to set up the files and programmes and update them.

A first input E1 relates to the clients and the local stations STi.

The term “client” may cover a single local station or a group of local stations, depending on whether the client is an independent site or a site dependent on a chain such as a chain of hypermarkets, or whether a station, even if it belongs to a chain is to be processed differently from another station in the same group. Depending on the circumstances, the information will be strictly customised for a site or alternatively certain sites belonging to a same chain will have shared information (music samples and messages).

A local station may also be divided into defined sectors or physical zones, in which a specific animation can be created. The information destined for this local station will therefore have specific addresses by which it is directed to the sectors or physical zones for which it is intended. Consequently, each zone will have a specific programme with a grid for a music programme, animated audio, video and sensory messages, the management function being handled centrally by the local station.

This input E1 therefore transmits the information INF/CL to the microcomputer μP. This transmitted information identifying the clients and sites and also defining the parameters of the public present at the site at any given time, the client's requirements in terms of the ambience to be created and any demographic and marketing information which might help in devising the music sample programmes.

A second input E2 corresponds to the pieces of music making up the music bank BMUS. The pieces of music are entered in the music bank together with information identifying them. The music samples are recorded in the music bank in the compressed state.

The bank may hold something in the order of 5 to 10,000 music samples, for example, each corresponding on average to a piece of variety music (lasting 3 to 5 minutes).

These samples are updated on the basis of their release and their interest. The music bank is replaced periodically.

A third input E3 at the centre C is that used for the audio, video and sensory animation messages and the programme grid. The messages are requested by the client. These messages are fixed for a given period. They may also be broadcast on an exceptional and one-off basis.

The animation messages covered by the present system include all types of animation messages intended to create an ambience and are not subject to the same constraints as the compressed or non-compressed music messages. The messages may be voice messages such as announcements and in particular commercial, publicity and promotional announcements as well as functional messages tantamount to instruction signals. The instruction signals may issue commands to the local animation systems or create atmosphere such as with lighting systems or perfume or smell diffusers or atomisers, operated on the basis of the communicated message in conjunction with the audio broadcasting system.

The input E3 for the messages operates as a message updating system; following the first messages associated with a station, the subsequent messages are regarded as updates (delete old messages and create new messages).

The messages are written to the message file F-MESS at the centre C. Messages and music samples to be broadcast by a local station STi are timed using a grid. This grid is also stored at the centre C in a planner file F-AG which contains the date of events (day and time at which a music sample or message will be broadcast).

This grid also needs to be updated to amend the timing or day of broadcast or delete an event if the message corresponding to it is deleted.

Finally, the centre C has a direct access input E4 enabling a message ACCDIR to be transmitted directly to the local station in order to broadcast a non-programmed message without this message having to be pre-registered in the local station.

Here too, the message may be a combination of a voice message and another ambience-creating message such as a sound effect, an audio-visual animation and/or atomisation or diffusion of a perfume or smell, controlled by the signal sent to a local atomiser or diffuser.

Depending on the information received, the microcomputer μp establishes the musical compilation programme, i.e. the sequence of samples, the list of messages and the planners for each local station, either automatically or on an assisted basis.

Once all the elements associated with a local station STi are ready, they are transmitted to this station via the modem MEDS at the centre, using the switched telephone network PSTN, for example.

The non-audio information in the programme files and optionally also the audio messages or instruction signals are transmitted directly via modem whereas the music samples ECHi are transmitted from the music bank BMUS after compression COMP to the modem MODS and the transmission line and on to the local addressee station STi.

The centre C communicates with different stations STi/STj, which are configured in exactly the same way. FIG. 1 merely illustrates the structure of the station STi.

The station STi is made up of a microcomputer or microprocessor μPi, connected to a PSTN modem or high-speed Internet link MODE to the modem of the centre C. The station also has at least one hard disk DDi (depending on the volume of information to be received). Each hard disk or partition of said hard disk DDi contains the samples ECRi, compressed data, the messages and the programme compilations.

The station STi also has a decompression means DECOMP at its output. The compression/decompression process is operated using the MP3 process, for example.

The station STi is connected to the audio system SONO.

The station STi may also be connected to one or more communication peripherals, the purpose of which will be to:

broadcast mono, stereo or quadraphonic audio samples,

broadcast digital images, video clips or films,

control the relays enabling sensory diffusers, lights or any other electrical contact to be switched on or off,

compile information arriving from various sensors (volume, brightness, level of a liquid, alarms) and despatch them to the local station STi. The behaviour of the local station may be automatically modified by the arrival of this information.

A communication peripheral is an electronic card, provided on each broadcasting zone;

a 10 or 100 Base T Ethernet interface to which the local station STi will be connected via a local network.

a random access memory,

a microprocessor,

a ROM memory module in which the data management programme will be stored,

an optional serial interface,

a MP3 audio data decoder,

a DivX or MPEG2 video data decoder,

a D/A converter,

a stereo audio pre-amplifier,

a power supply,

8 relay outputs,

8 opto-coupler inputs,

an optional volume measuring module,

an optional module for controlling operation of external amplifiers.

The audio and video data are sent raw (compressed) by the local station STi to the communication peripheral of the zone in question. The purpose of the communication peripheral is to acquire them (Ethernet interface) and store them temporarily in a buffer memory of the FIFO type so that each data packet can then be decoded by the MP3 or DivX decoder. Once decompressed, the audio data is sent to a pre-amplifier, which will in turn be connected to the audio system of the client. The video data will be sent directly to a peripheral (monitor, television set, LCD screen, image wall or video projector) installed at the client.

The 8 relay outputs are able to control 8 peripherals independently (sensory diffusers, lighting, alarm, amplifiers etc.).

The 8 opto-coupler inputs may receive the information sent by 8 independent sensors.

Once it has received the various systems and its operating programme, the local station STi operates autonomously. The different events are triggered by the clock in accordance with the programme, which retrieves the music samples ECHi one after the other, inserting the message at the appropriate time. The music samples are transmitted to the audio system after real-time decompression, i.e. at the time of the transmission.

The different functions for planning the music programmes, occupying the time available, creating programmes or the broadcasting grid and all the functions associated therewith as well as managing the programmes and managing the broadcast are all operations run by the centre and will be described in detail below.

The music bank incorporates various functions. It compiles music programmes depending on an assessment issued after analysing a questionnaire submitted to the client about his public or commercial environment, completed by the latter and corresponding to the site for which the programme is intended. The music programme is compiled on this basis. These programmes are compiled in accordance with criteria and from analysis of the questionnaire, depending on the client's requirements. The numbers of programmes which the bank can manage are virtually unlimited.

In devising programmes, the time is cut into slots depending on various criteria.

For each zone, the choice of musical rhythm (Bit Per Minute) is displayed on each time slot on a scale of from one to five levels, for example, as desired by the client and resulting from the assessment. A more refined division may also be envisaged.

The compilation of music programmes also includes the music genre selected by the client depending on the musical tone he wishes to impart to the audio system.

The design functions of the bank also manage the broadcasting frequency in accordance with certain rules such as French, international or themed titles or alternatively the frequency with which new features are broadcast relative to the standard pieces of music.

The rate of repetition of a same title within a same programme is also defined. In the same line of thinking, the minimum period within which a specific title may occur within a same programme is defined. Finally, the sound volume is managed on a scale of 1 to 19, for example, in the programme or in each time slot.

A certain number of programmes meeting a catalogue of criteria can be generated automatically.

In this programme creation phase, a root is entered, to which a suffix corresponding to the programme numbers is added. The elements required for the programme are copied onto the storage unit of the client. Once programmes have been automatically generated, a list of contents for each programme is created showing the titles, performers and duration, which can be deployed through a conventional spreadsheet.

The planner function sets up a broadcasting grid containing the programmes and messages. This grid is organised by day and by time, divided into 3 minute slots over 24 hours. The planner automatically integrates the daily music programmes into a given period with a selection of day types during which the programmes must be broadcast. The planner creates masks for fixed messages which are intended to be repeated daily at a fixed time. It also automatically generates message programmes which can appear at random during the broadcasting period.

The planner also has functions for repeating and cancelling operations as well as a stop function, which enables a stopping point to be inserted for the music programme.

This planner function generates two broadcasting lists:

a list categorized by titles and messages giving the day and time at which each title and message will be broadcast,

a list categorised by date of broadcasting giving titles and messages broadcast per day.

The programme manager has a create function, i.e. programmes or a sample in a programme can be created, saved, edited and deleted manually rather than automatically.

The programmes are compiled manually from the music bank and the messages filed, in particular, by performer, title, rhythm, style, language and duration; the selection is made intuitively on the basis of specified criteria.

This manager manages the data base depending on the titles contained on the disks and repertories.

The broadcasting manager contains all the titles and messages filed in the programme manager on the basis of an intuitive search. This manager contains all the programmes. It manages the volumes and interrupt modes, i.e. when a title is interrupted by a message, sample or programme, the title is handled in the selected mode, either interrupted at the selected point or by skipping to the next title or halting the programme. This manager also reads directly the titles or programmes launched manually or automatically by the planner.

The music bank is managed by means of a spreadsheet containing the criteria relating to each sample such as performer, title, file name, format, internal reference of the title, file size, date on which the title was placed in the bank, style, language, etc.

In the music bank, the periods of silence known as “blanks” in a title or sample or between the messages are deleted.

The volume levels of the different samples are also regulated relative to one another following a predefined volume curve based on time (time of day, numbers of visitors, etc.); the bank also contains a set of audio introductions known as “jingles” in the form of samples, which may be conventional or customised, possibly specially written.

As explained above, communication for exchanging data between the centre and the local stations is by modems either via the public telephone network PSTN or by a high-speed Internet link, using the PPP protocol (Point to Point Protocol) and the FTP protocol. It is also possible, even of practical interest, to use Internet transmission, which will enable the major part of the data processing to be automated. Consequently, the client can formulate his requests directly through applications available on the Internet with security-protected access. These applications are as follows:

control of messages or samples with corresponding instructions,

preview hearings of messages or samples online to check them and amend the contents of existing or future programmes,

look up broadcasting lists; performers, titles, schedules with possible print-outs;

account monitoring for the client,

e-mail correspondence between the clients and the centre,

“online Hot Line” service, online account statistics, online account automation,

control robots checking data integrity and correct operation of the terminal at the client. This module enables permanent monitoring to ensure that each active terminal is operating correctly, immediately alerting engineers in the event of malfunction.

Each client has personalised access to the Internet. This access is secure.

Consequently, the client has permanent uninterrupted access directly to the site of the centre. The permanent client access 1s preferably by high-speed Internet, CABLE, ADSL or radio in the local loop.

1) Adaptable, personalised and sector-based animation system for transmitting a music programme, messages, smells, digital images and lights on the basis of pre-established but adaptable programmes,
characterised in that it comprises
a management and control centre linked to at least one local station connected to an animation system incorporating an audio system to which it supplies the audio signals to be transmitted,
A) the centre (C) comprising
a micro-computer (μP) managing
a music bank (BMUS) containing available music samples (ECHi) to compile music programmes for broadcasting,
a file of sample programmes (F-PRECH),
a file of animation messages (F-MESS),
a planner file (FAGEN) containing the broadcasting grids (broadcasting time of the sample programmes and messages) based on days and times of the day,
a file of clients and local stations (F-CL/-STi) linked to the centre (C),
input means (E1, E2, E3) for
musical data to set up, add to and renew the music bank by adding or deleting samples,
data relating to the clients,
information for updating client data,
direct access means (ACCDIR) for accessing a local station (STi), the priority being its programmed operation,
an audio data compression (COMP) means,
a modem (MODE) outputting from the centre (C) in order to communicate with the local stations (STi),
B) at least one local station (STi) comprising
a central unit (μPI) and at least one hard disk (DDI) receiving
the compressed samples, the compressed messages and the samples programmes associated with the local station,
a decompression means at the station output,
a modem (MODE) at the input of the local station to communicate with the centre (C),
C) the centre (C) compiling, for each local station (STi) or group of local stations,
a programme of samples and animation messages containing the sample and message references,
a planner for the samples and messages (broadcasting dates),
the programme of samples being compiled on the basis of information describing the site at which the sound system is located,
the centre transmitting to each local station
the compressed samples and messages, the programmes of samples and messages and the planner for recording them in the local station,
the transmission of signals to the audio system (SONO) being managed locally by the central unit (μPI) of the local station (STi) on the basis of the programme of samples and messages and the planner,
the audio signals being decompressed at the station output before being applied to the audio system.

2) Personalised and sector-based animation system as claimed in claim 1,
characterised in that
the centre (C) transmits the information and the files to a local station (STi) via the telephone network (PSTS).

3) Personalised and sector-based animation system as claimed in claim 1,
characterised in that
the centre (C) transmits the information and the files to a local station (STi) via the Internet.

4) Personalised and sector-based animation system as claimed in claim 1,
characterised in that
the centre (C) is accessed via the Internet.

5) Personalised and sector-based animation system as claimed in claim 1,
characterised in that
the centre (C) generates two broadcasting lists
a list categorised by titles and messages giving the day and time at which each title and message will be broadcast,
a list categorised by date of broadcasting giving titles and messages broadcast per day,

6) Personalised and sector-based animation system as claimed in claim 1,
characterised in that
the animation messages include voice messages, audio messages, digital video messages and sensory messages.

7) Personalised and sector-based animation system as claimed in claim 6,
characterised in that
the light messages and sensory messages include command signals for local broadcasting systems such as lighting and video projector systems, and atomisers or diffusers for perfume and smell.
